(19) United States
(12) Patent Application Publication
(10) Pub. No.: US 2018/0189416 A1
(43) Pub. Date: Jul. 5, 2018

(54) METHOD AND APPARATUS FOR VISUALIZING RELATIONS BETWEEN INCIDENT RESOURCES

(71) Applicant: KOREA INTERNET & SECURITY AGENCY, Seoul (KR)

(72) Inventors: SeuI Gi Lee, Seoul (KR); Hyei Sun Cho, Seoul (KR); Nak Hyun Kim, Seoul (KR); Byung Ik Kim, Seoul (KR); Tae Jin Lee, Seoul (KR)

(21) Appl. No.: 15/420,905

(22) Filed: Jan. 31, 2017

(30) Foreign Application Priority Data
Jan. 5, 2017 (KR) 10-2017-0001757

(51) Int. Cl. G06F 17/30; G06T 11/20

(52) U.S. Cl. CPC G06F 17/30958; G06T 2200/24; G06F 17/30557; G06T 11/206

(57) ABSTRACT

Disclosed are methods and programs for visualizing relations between incident resources using a graph database including a plurality of resource nodes and edges connecting the plurality of resource nodes, one of the methods comprises generating a first incident resource set including one or more nodes connected to a first incident resource node, which is one of the plurality of resource nodes, by N or less edges (where N is a natural number not less than 1), generating a second incident resource set including one or more nodes connected to a second incident resource node, which is another one of the plurality of resource nodes, by N or less edges, setting a first flag bit of the nodes included in the first incident resource set and a second flag bit of the nodes included in the second incident resource set to a first value, classifying the nodes included in each of the first and second incident resource sets based on the values of the first and second flag bits of each of the nodes included in each of the first and second incident resource sets, identifying one or more nodes belonging to both the first and second incident resource sets based on the result of the classification, and determining that there is a relation between the first and second incident resource nodes if there exists one or more nodes belonging to both the first and second incident resource sets.

This application claims priority to Korean Patent Application No. 10-2017-0001757, filed on Jan. 5, 2017, and all the benefits accruing therefrom under 35 U.S.C. § 119, the disclosure of which is incorporated herein by reference in its entirety.

### BACKGROUND

### 1. Field

The present disclosure relates to a method and apparatus for visualizing relations between incident resources, and more particularly, to a method and apparatus for visualizing relations between incident resources using a graph database.

### 2. Description of the Related Art

In order to deal with incidents that are on a rapid increase, information regarding incidents is increasingly shared between domestic and foreign public institutions and between private companies. In addition, various methods have been employed to defend against attacks launched by incident resources by refining and managing shared information regarding incidents into intelligence information.

As an example, a method of analyzing relations between incident resources has been proposed. According to this method, the elements of each of a plurality of incident resources are compared with one another to determine relations between incident resources and to prevent any future attacks launched by the incident resources based on the result of the comparison. However, in general, each of the incident resources and the elements of each of the incident resources are established as a relational database (RDB). Thus, to determine the relations between the incident resources, processes of searching and comparing the elements of each of the incident resources are needed, and particularly, a computation process for comparing relations between one incident resource and multiple incident resources becomes very complex. In addition, even if the relations between the incident resources can be analyzed based on the RDB, the result of the analysis cannot be visualized, and thus, it may be difficult to intuitively identify the relations between the incident resources.

However, no method has yet been proposed for analyzing and visualizing relations between incident resources by building a graph database having the incident resources and the elements of each of the incident resources as its nodes so as to minimize a computation process.

### SUMMARY

Exemplary embodiments of the present disclosure provide a method of providing information regarding relations between incident resources using a graph database.

More specifically, exemplary embodiments of the present disclosure provide a method of analyzing relations between incident resources based on the distances among the nodes of a graph database.

Exemplary embodiments of the present disclosure also provide a method of grouping and managing elements within a predefined distance of a node corresponding to an incident resource to be analyzed.

More specifically, exemplary embodiments of the present disclosure also provide a method and apparatus for analyzing a relation between an incident resource and its elements by identifying unique flag bits allocated to each element included in an incident resource set.

Exemplary embodiments of the present disclosure also provide a method and apparatus for visualizing relations between incident resources and providing the result of the visualization through a graphic user interface (GUI).

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the present disclosure, a method for visualizing relations between incident resources using a graph database including a plurality of resource nodes and edges connecting the plurality of resource nodes comprises generating a first incident resource set including one or more nodes connected to a first incident resource node, which is one of the plurality of resource nodes, by N or less edges (where N is a natural number not less than 1); generating a second incident resource set including one or more nodes connected to a second incident resource node, which is another one of the plurality of resource nodes, by N or less edges; setting a first flag bit of the nodes included in the first incident resource set and a second flag bit of the nodes included in the second incident resource set to a first value; classifying the nodes included in each of the first and second incident resource sets based on the values of the first and second flag bits of each of the nodes included in each of the first and second incident resource sets; identifying one or more nodes belonging to both the first and second incident resource sets based on the result of the classification; and determining that there is a relation between the first and second incident resource nodes if there exists one or more nodes belonging to both the first and second incident resource sets.

The method further comprises in response to it being determined that there is a relation between the first and second incident resource sets, generating a graph including the first and second incident resource sets and the nodes belonging to both the first and second incident resource sets; and displaying the graph through a graphic user interface (GUI) for relation visualization, wherein the graph is a graph in which the nodes belonging to both the first and second incident resource sets are connected to each of the first and second incident resource nodes by edges.

The nodes belonging to both the first and second incident resource sets may be nodes whose first and second flag bits are both set to the first value.

The classifying the nodes included in each of the first and second incident resource sets, comprises creating an indicator of each of the nodes included in each of the first and second incident resource sets by combining the values of the first and second flag bits of each of the nodes included in each of the first and second incident resource sets; and classifying the nodes included in each of the first and second incident resource sets based on the indicators of the nodes included in each of the first and second incident resource sets.

The method further comprises, in response to there existing multiple nodes belonging to only one of the first and second incident resource sets among the classified nodes, determining that there is a relation only between the multiple nodes.

According to another exemplary embodiment of the present disclosure, a computer program, for visualizing relations between incident resources using a graph database including a plurality of resource nodes and edges connecting the plurality of resource nodes, which is coupled with a computer device and stored in a non-transitory computer readable recording medium, is provided, and the computer program is configured to execute generating a first incident resource set including one or more nodes connected to a first incident resource node, which is one of the plurality of resource nodes, by N or less edges (where N is a natural number not less than 1), generating a second incident resource set including one or more nodes connected to a second incident resource node, which is another one of the plurality of resource nodes, by N or less edges, setting a first flag bit of the nodes included in the first incident resource set and a second flag bit of the nodes included in the second incident resource set to a first value, classifying the nodes included in each of the first and second incident resource sets based on the values of the first and second flag bits of each of the nodes included in each of the first and second incident resource sets, identifying one or more nodes belonging to both the first and second incident resource sets based on the result of the classification, and determining that there is a relation between the first and second incident resource nodes if there exists one or more nodes belonging to both the first and second incident resource sets.

According to another exemplary embodiment of the present disclosure, a method for visualizing relations between incident resources using a graph database including a plurality of resource nodes and edges connecting the plurality of resource nodes comprises receiving information regarding each of multiple incident resources, identifying multiple incident resource nodes mapped to the multiple incident resources, respectively, from among the plurality of resource nodes in response to receipt of the information, determining an incident resource set including each of the multiple incident resource nodes and one or more nodes connected to a corresponding incident resource node by N or less edges (where N is a natural number not less than 1), in response to there existing one or more nodes belonging to two or more incident resource sets among the nodes included in the determined incident resource set, generating a graph including the one or more nodes and incident resource nodes corresponding to the two or more incident resource sets, respectively, that the one or more nodes belong to, and displaying the graph through a GUI for relation visualization.

The determining the incident resource set, comprises setting a flag bit of the nodes included in each of the multiple incident resource sets to a first value and determining, based on the result of the setting, that the one or more nodes belong to the two or more incident resource sets.

The generating the graph, comprises, in response to there existing more than one node belonging to two or more incident resource sets among the nodes included in the determined incident resource set, generating a graph displaying an object that shows the number of nodes belonging to two or more incident resource sets among the nodes included in the determined incident resource set.

According to another exemplary embodiment of the present disclosure, a computer program, for visualizing relations between incident resources using a graph database including a plurality of resource nodes and edges connecting the plurality of resource nodes, which is coupled with a computer device and stored in a non-transitory computer readable recording medium, is provided, and the computer program is configured to execute receiving information regarding each of multiple incident resources, identifying multiple incident resource nodes mapped to the multiple incident resources, respectively, from among the plurality of resource nodes in response to receipt of the information, determining an incident resource set including each of the multiple incident resource nodes and one or more nodes connected to a corresponding incident resource node by N or less edges (where N is a natural number not less than 1), in response to there existing one or more nodes belonging to two or more incident resource sets among the nodes included in the determined incident resource set, generating a graph including the one or more nodes and incident resource nodes corresponding to the two or more incident resource sets, respectively, that the one or more nodes belong to; and displaying the graph through a GUI for relation visualization.

According to the above and other exemplary embodiments of the present disclosure, distance-based analysis can be performed incident resources.

In addition, by using a graph database, a computation process for comparing the elements of each incident resource can be minimized. That is, elements belonging to multiple incident resources can be easily identified simply by identifying the values of flag bits allocated to the particular elements without the need to compare the values of the particular elements.

Moreover, relations between incident resources are provided via a GUI and can thus be intuitively analyzed.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a block diagram of a system for visualizing relations between incident resources according to an exemplary embodiment of the present disclosure;

FIG. 2 is a diagram illustrating graph database according to some exemplary embodiments of the present disclosure;

FIG. 3 is a hardware block diagram of an apparatus for visualizing relations between incident resources according to an exemplary embodiment of the present disclosure;

FIG. 4 is a flowchart illustrating a method of visualizing relations between incident resources according to an exemplary embodiment of the present disclosure;

FIG. 5 is a flowchart illustrating the allocation of flag bits, as performed in the method according to the exemplary embodiment of FIG. 4;

FIG. 6 is a diagram illustrating an interface for relation search according to some exemplary embodiments of the present disclosure;

FIGS. 7 and 8 are diagrams illustrating incident resource nodes and incident resource sets according to some exemplary embodiments of the present disclosure; and

FIGS. 9 through 11 are diagrams illustrating a graphic user interface (GUI) for relation visualization according to some exemplary embodiments of the present disclosure.

### DETAILED DESCRIPTION

Embodiments of the present inventive concept will hereinafter be described in detail with reference to the attached drawings. The advantages and features of the present inventive concept and methods for accomplishing the same will become apparent by referring to the preferred embodiments thereof described below with reference to the attached drawings. The present inventive concept may, however, be embodied in different forms and should not be construed as limited to the embodiments set forth herein. Rather, these embodiments are provided so that this disclosure will be thorough and complete, and the present inventive concept will be defined by the scope of claims. Throughout the description, identical reference numerals are used to designate identical elements.

Unless defined otherwise, all terms (including technical and scientific terms) used herein have the same meaning as commonly understood by one of ordinary skill in the art to which the present inventive concept belongs. Further, unless expressly defined otherwise, all terms defined in generally used dictionaries may not be interpreted in an idealized or overly sense. It will also be understood that the terms may be used herein to describe embodiments, and may not intended to limit the scope of the present disclosure. As used herein, the singular forms are intended to include the plural forms as well, unless the context clearly indicates otherwise.

The term “incident,” as used herein, refers to a case in which a malicious act is performed on assets constituting an information processing system. Also, the term “incident resources,” as used herein, refers to all information associated with an incident, such as a malicious agent or infrastructure and malicious tools used to perform a malicious act, for example, Internet protocol (IP) addresses, domains, emails, malicious codes, and the like.

Exemplary embodiments of the present disclosure will hereinafter be described with reference to the accompanying drawings.

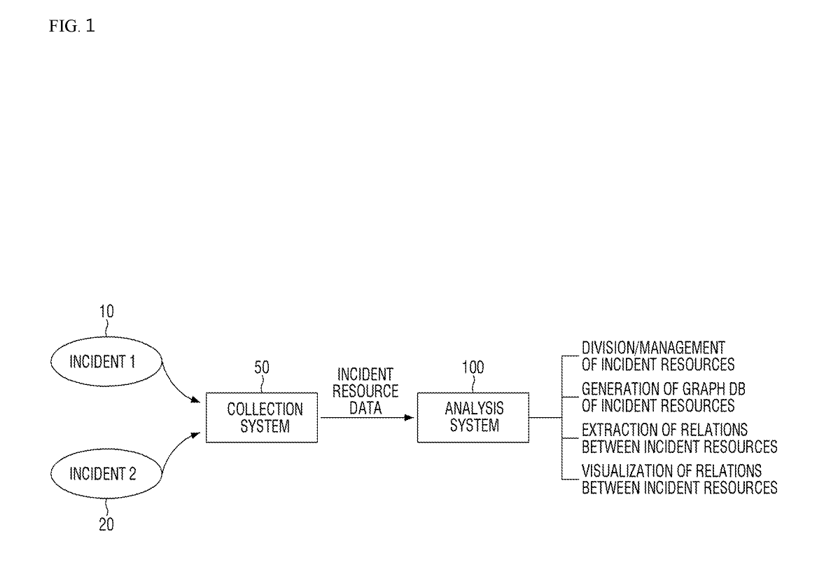

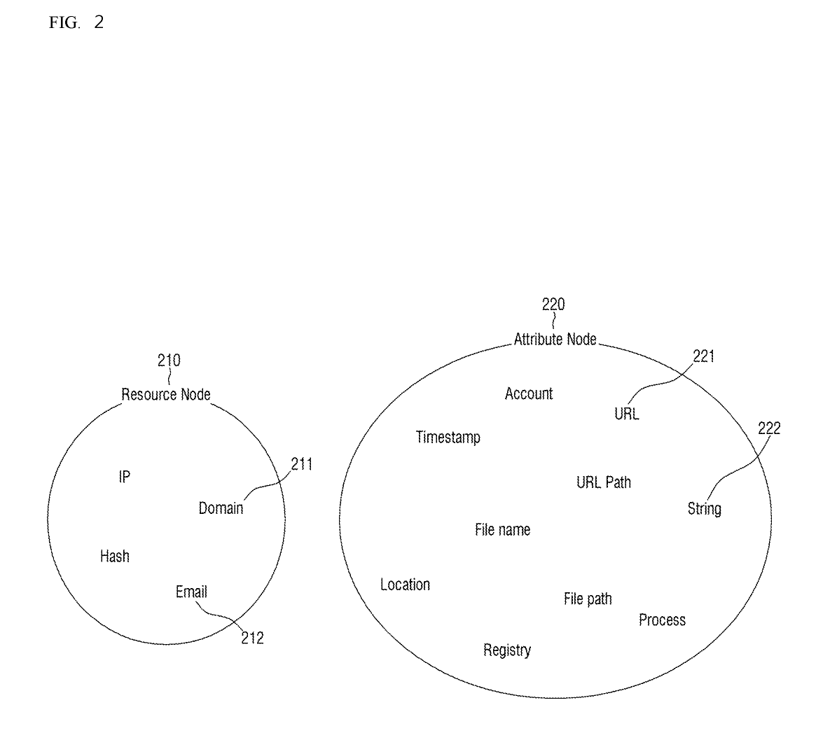

FIG. 1 is a block diagram illustrating a system for visualizing relations between incident resources according to an exemplary embodiment of the present disclosure. FIG. 2 is a diagram illustrating graph database according to some exemplary embodiments of the present disclosure.

Referring to FIG. 1 the system may include at least one collection system 50 and an analysis system 100. The system may be, for example, an accumulated and integrated intelligence system (AEGIS). The collection system 50 and the analysis system 100 may be systems one or more computing devices that are networked and are capable of communicating with each other.

The collection system 50 may collect various information regarding incident resources that have caused an incident. For example, the collection system 50 may receive an incident resource that has caused incident 1 (10) and an incident resource that has caused incident 2 (20). If the incident resource that has caused incident 1 (10) or the incident resource that has caused incident 2 (20) is a malicious code, the collection system 50 may receive a hash value of the malicious code.

The collection system 50 not only can receive incident resources through various external channels, but also can actively collect incident resources according to input from a user and/or an administrator of the system. In this case, in response to a hash value being received from the user and/or the administrator, the collection system 50 may actively collect information regarding a string, which is an element of the received hash value, and a channel that has allocated the received hash value.

The analysis system 100 may divide and manage the incident resources collected by the collection system 50. The analysis system 100 may store the divided and managed incident resources as a graph database. By using the graph database, the analysis system 100 may determine relations between incident resources and may visualize the determined relations through a graphical user interface (GUI).

In some exemplary embodiments, the analysis system 100 may display the visualized relations through a display device, and may include an input device for receiving input from the user and/or the administrator through a GUI. The analysis system 100 may be referred to as an apparatus for visualizing relations between incident resources, as long as the analysis system 100 can display visualized relations between incident resources.

In other exemplary embodiments, the system may further include a computing device in addition to the collection system 50 and the analysis system 100. For example, the system may include any one of a smart phone, a laptop computer, a personal digital assistant (PDA), a portable multimedia player (PMP), a navigation device, a slate personal computer (PC), a tablet PC, a desktop computer, and the like as the computing device. The computing device may display a GUI created by the analysis system 100 to the user and/or the administrator. In this case, the computing device may be provided with a GUI by the analysis system 100.

FIG. 1 illustrates the collection system 50 and the analysis system 100 as being separate elements of the system, but the collection system 50 and the analysis system 100 may be integrated into a single system.

FIG. 2 illustrates graph database according to some exemplary embodiments of the present disclosure.

In order to store incident resources collected by the collection system 50, the analysis system may classify the collected incident resources into resource nodes and attribute nodes. In response to a hash value and a string of a malicious code, which is a type of incident resource, being received from the collection system 50, the analysis system 100 may set the received hash value as a resource node and may allocate a resource identifier (RID) to the resource node. Also, the analysis system 100 may set the received string, which is an element of the received hash value, as an attribute node and may allocate an attribute identifier (AID) to the attribute node.

The analysis system 100 connects resource nodes and attribute nodes with edges, thereby setting relationships between the resource nodes and the attribute nodes.

FIG. 2 illustrates nodes set as resource nodes 210 and nodes set as attribute nodes 220. For example, the resource nodes 210 may include a domain node 211 and an email node 212, and the attribute nodes 220 may include a universal resource locator (URL) 221 and a string 222.

Once the resource nodes 210 and the attribute nodes 220 are set and the relationships the resource nodes 210 and the attribute nodes 220 are set as edges, a graph database may be established.

Resource nodes and attribute nodes of the graph database may be connected by edges, the resource nodes may be connected to one another by edges, and the attribute nodes may be connected to one another by edges.

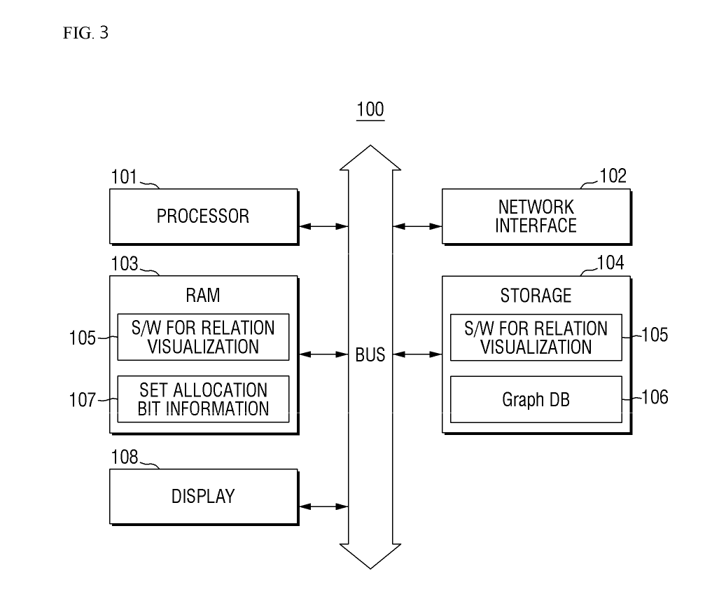

FIG. 3 is a hardware block diagram of an apparatus for visualizing relations between incident resources according to an exemplary embodiment of the present disclosure. It is assumed that the analysis system 100 is an apparatus 100 for visualizing relations between incident resources.

Referring to FIG. 3, the apparatus 100 may include at least one processor 101, a network interface 102, a memory 103, which loads a computer program 105 executed by the processor 101, and a storage 104, which stores the computer program 105.

The processor 101 controls the general operation of each of the elements of the apparatus 100. The processor 101 include a central processing unit (CPU), a micro processing unit (MPU), a micro controller unit (MCU), or any other arbitrary processor that is already well known in the art to which the present disclosure pertains. The processor 101 may perform computation on at least one application or program for executing a method of visualizing relations between incident resources according to some exemplary embodiments of the present disclosure. The apparatus 100 may include more than one processor 101.

The network interface 102 supports wired/wireless Internet communication or intranet communication of the apparatus 100. Also, the network interface 102 may support various communication methods other than Internet communication and intranet communication. To this end, the network interface 102 may include at least one communication module that is already well known in the art to which the present disclosure pertains.

The network interface 102 may be connected, via a network, to the collection system 50 and/or a system to be monitored and may also be connected to a computing device. The network interface 102 may receive information regarding collected incident resources and monitoring result data and may transmit information regarding relations between the collected incident resources, the result of visualization of the relations between the collected incident resources, and various GUIs.

The memory 103 stores various data, commands, and/or information. The memory 103 may load at least one program 105 from the storage 104 to implement a method of visualizing relations between incident resources according to some exemplary embodiments of the present disclosure. The memory 103 may be, for example, a random access memory (RAM), and may be configured to include at least one of various types of RAMs that are widely used in the art to which the present disclosure pertains, such as a static RAM (SRAM), a dynamic RAM (DRAM), a pseudo-SRAM (PSRAM), a synchronous DPARM (SDRAM), and a double data rate (DDR) SDRAM. The memory 103 loads the program 105 stored in the storage 104 to be executed by the processor 101.

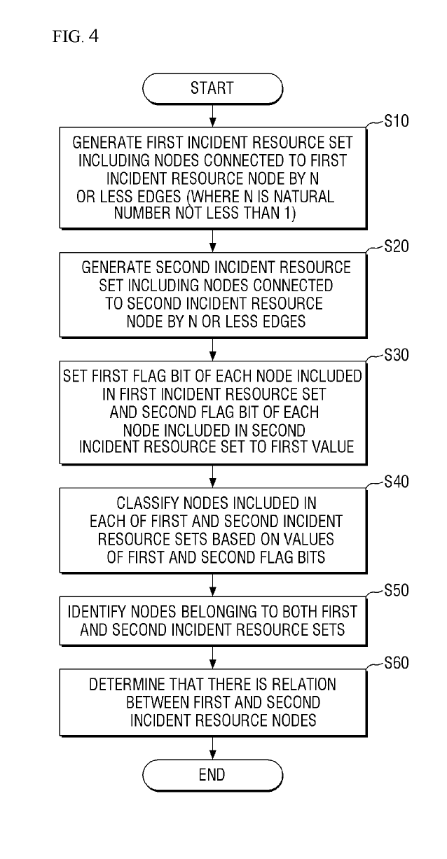

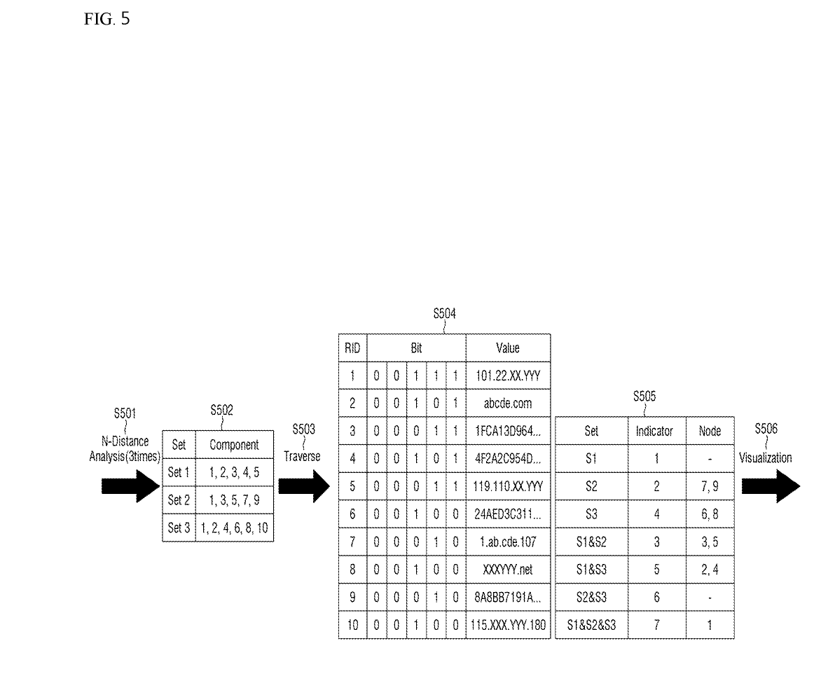

FIG. 3 illustrates software 105 for relation visualization as an example of the program 105 stored in the storage 104. In response to the software 105 being executed by the processor 101 one or more operations may be performed to perform the functions and/or the operation of the apparatus 100, and this will be described later with reference to FIGS. 4 and 5.

During the execution of the software 105, a bit value is recorded in a flag bit allocated to each incident resource set. The bit value may be stored volatilely in the memory 103.

More specifically, during the execution of the software 105 by the processor 101, the apparatus 100 receives input incident resources to be analyzed from the user and/or the administrator. At this time, not only the number of incident resource sets created, but also the digit place of a flag bit allocated to each of the created incident resource sets, varies depending on the number of received incident resources. Since the value of the flag bit allocated to each of the created incident resource sets can be recorded only when the number of incident resource sets is determined, the value of the flag bit allocated to each of the created incident resource sets may be temporarily stored in the memory 103. That is, not only the digit place, but also the value, of the flag bit allocated to each of the created incident resource sets may change whenever the apparatus 100 analyzes and visualizes relations between incident resources. Set allocation bit information 107, which is stored in the memory 103, is information regarding the digit place and the value of the flag bit allocated to each of the created incident resource sets, which are determined according to the number of input incident resources.

The storage 104 may non-temporarily store the software 105, which is an example of the program 105. The storage 104 may also store a graph database 106 of incident resources. The storage 104 may also store various information for performing a method of visualizing relations between incident resources according to some exemplary embodiments of the present disclosure.

The storage 104 may be implemented as a nonvolatile memory such as a read only memory (ROM), an erasable programmable ROM (EPROM), an electrically erasable programmable ROM (EEPROM), or a flash memory, a hard disk, a removable disk, or an arbitrary computer-readable recording medium that is already well known in the art to which the present disclosure pertains.

The apparatus 100 may further include a display 108. The display 108 may output various interfaces used to perform a method of visualizing relations between incident resources according to some exemplary embodiments of the present disclosure. Also, the display 108 may display the result of the execution of the software 105.

Meanwhile, the apparatus 100 may further include various elements other than those illustrated in FIG. 3. For example, the apparatus 100 may further include an input unit for receiving input regarding incident resources, a search depth for visualizing relations between the incident resources, and a search period and various settings regarding the incident resources from the user and/or the administrator.

The operation of the apparatus 100 will hereinafter be described. It is assumed that steps that will hereinafter be described are performed by the apparatus 100.

FIG. 4 is a flowchart illustrating a method of visualizing relations between incident resources according to an exemplary embodiment of the present disclosure.

The graph database 106, which is stored in the apparatus 100, may include a plurality of resource nodes and edges among the plurality of resource nodes. A method of visualizing relations between incident resources by using the graph database 106 will hereinafter be described with reference to FIG. 4. It is assumed that the plurality of resource nodes include first and second incident resource nodes.

The first and second incident resource nodes may be nodes matched to incident resources input to the apparatus 100 by the user and/or the administrator.

For example, the first and second incident resource nodes may be nodes input by the user and/or the administrator via a GUI provided by the software 105 or may be nodes matched to a hash value or some elements of a selected incident resource such as, for example, a malicious code or a domain.

In response to at least one incident resource being input, the apparatus 100 may search for and find one or more nodes matched to the input incident resource from the graph database 106.

Once the first and second incident resource nodes are found, the apparatus 100 may create a first incident resource set including nodes connected to the first incident resource node, among other resource nodes, by N or less edges (S10). The apparatus 100 may also create a second incident resource set including nodes connected to the second incident resource node, among other resource nodes, by N or less edges (S20).

N is a natural number not less than 1 and may be determined in advance by the user and/or the administrator. Alternatively, N may be determined in advance by the apparatus 100. For example, N=5.

The first incident resource set may include nodes within a predetermined depth of the first incident resource node, and the second incident resource set may include nodes within a predetermined depth of the second incident resource node. For example, in a case in which N=3, the first incident resource set may include nodes that are connected to the first incident resource node by three or less edges. The first incident resource set may include the first incident resource node, but the present disclosure is not limited thereto. For example, in a case in which there are node 1 connected to the first incident resource node by edge 1, node 2 connected to node 1 by edge 2, and node 3 connected to node 2 by edge 3, the first incident resource set may include nodes 1, 2, and 3, which are all connected to the first incident resource node by three or less edges. In this example, the first incident resource node is connected not only to node 1, but also to other nodes by multiple edges, in which case, the first incident resource set may include nodes connected to the other nodes connected to the first incident resource node.

After the creation of the first and second incident resource sets, the apparatus 100 sets a first flag bit of each of the nodes included in the first incident resource set to a first value and sets a second flag bit of each of the nodes included in the second incident resource set to the first value (S30).

The apparatus 100 may allocate unique flag bits to each node included in each incident resource set.

For example, in a case in which two incident resource sets, for example, the first and second incident resource sets, are created, the apparatus 100 may allocate two flag bits to each of the nodes included in the first or second incident resource set. The apparatus 100 may allocate the first and second flag bits to different digit places. Each of the first and the second flag bits may have different digit places. The digit place of the first flag bit may be adjacent to the digit place of the second flag bit.

For example, the first flag bit may be inserted into a first digit place in front of each node value, and the second flag bit may be inserted into a second digit place in front of the first digit place. Accordingly, as many flag bits as there are incident resource sets created in S10 and S20, i.e., two flag bits, are inserted in front of each node value.

Once the first and second flag bits are inserted into each of the nodes of each of the first and second incident resource sets, the apparatus 100 may set a unique bit value corresponding to each of the first and second incident resource sets in each of he first and second flag bits.

For example, in S30, the first value may be “1”. In this example, a first-digit flag bit of each of the nodes included in the first incident resource set may be set to a value of “1”. Accordingly, each of the nodes of the first incident resource sets may have a “1” in their first-digit flag bit. A second-digit flag bit of each of the nodes included in the second incident resource set may be set to a value of “1”. Accordingly, each of the nodes of the second incident resource sets may have a “1” in their second-digit flag bit. A first-digit flag bit of each node not included in the first incident resource set may be set to a value of “0”, instead of a value of “1”, and a second-digit flag bit of each node not included in the second incident resource set may also be set to a value of “0”, instead of a value of “1”.

In another example, in S30, the first value may be “0”. In this example, the apparatus 100 may set the first-digit flag bit of each of the nodes included in the first incident resource set and the second-digit flag bit of each of the nodes included in the second incident resource set to a value of “0”.

The apparatus 100 may classify the nodes included in each of the first and second incident resource sets based on the values of the first and second flag bits of each of the nodes included in each of the first and second incident resource sets (S40). The apparatus 100 may identify one or more nodes belonging to both the first and second incident resource sets based on the result of the classification (S50).

Thereafter, in response to there existing nodes belonging to both the first and second incident resource sets, the apparatus 100 may determine that the first and second incident resource nodes are related (S60).

In response to the first and second incident resource nodes being determined to be related in S60, the apparatus 100 may create a graph including the first and second incident resource nodes and the nodes belonging to both the first and second incident resource sets. Then, the apparatus 100 may display the created graph via a GUI. The created graph may be a graph in which the nodes belonging to both the first and second incident resource nodes are connected to the first and second incident resource nodes by edges.

The method according to the exemplary embodiment of FIG. 4 will hereinafter be described in further detail with reference to FIG. 5.

FIG. 5 is a flowchart illustrating the allocation of flag bits, as performed in the method according to the exemplary embodiment of FIG. 4. Referring to FIG. 5, the apparatus may N-distance analysis on a plurality of incident resources (S501) by using the graph database 106 to analyze relations between the plurality of incident resources. N-distance analysis is a method of identifying a plurality of incident resource nodes matched to the plurality of incident resources, respectively, from the graph database 106 and searching for and finding nodes connected to each of the identified incident resource nodes by N or less edges.

In S10 and S20 of FIG. 4, the first and second incident resource sets may be created by performing N-distance analysis on the first and second incident resource nodes. It is assumed that in S502 of FIG. 5, three incident resource sets, i.e., first, second, and third incident resource sets “Set 1”, “Set 2”, and “Set 3”, are created. In the description that follows, it is assumed that numbers ranging from 1 to 10 are allocated to nodes as RIDs.

The first incident resource set “Set 1” includes nodes 1, 2, 3, 4, and 5 that are within a N-edge depth of the first incident resource node.

The second incident resource set “Set 2” includes nodes 1, 3, 5, 7, and 9 that are within the N-edge depth of the second incident resource node.

The third incident resource set “Set 3” includes nodes 1, 2, 4, 6, 8, and 10 that are within the N-edge depth of the third incident resource node.

The apparatus 100 may compare the nodes included in each of the first, second, and third incident resource sets “Set 1”, “Set 2”, and “Set 3” (S503). To this end, the apparatus 100 may insert a number of flag bits corresponding to the number of incident resource sets created in front of the node value of each of the nodes included in each of the first, second, and third incident resource sets “Set 1”, “Set 2”, and “Set 3”.

Since there are three incident resource sets created, the apparatus 100 may insert three flag bits in front of the node value of each of the nodes included in each of the first, second, and third incident resource sets “Set 1”, “Set 2”, and “Set 3”, and may set each of the three flag bits of each of the nodes included in each of the first, second, and third incident resource sets “Set 1”, “Set 2”, and “Set 3” to a predetermined value (S504).

Since node 1 belongs to the first incident resource set “Set 1”, a “1” is set in the place of a first-digit flag bit in front of the node value of node 1. Since node 1 also belongs to the second incident resource set “Set 2”, a “1” is also set in the place of a second-digit flag bit in front of the first-digit flag bit. Since node 1 also belongs to the third incident resource set “Set 3”, a “1” is also set in the place of a third-digit flag bit in front of the second-digit flag bit. That is, since node 1 belongs to all the first, second, and third incident resource sets “Set 1”, “Set 2”, and “Set 3”, the flag bits inserted in node 1 are all set to a value of “1”.

In this manner, the values of the flag bits inserted into each of nodes 2 through 10 may all be set. A “1” is set in the place of the first-digit flag bit of each node included in the first incident resource set “Set 1”, a “1” is set in the place of the second-digit flag bit of each node included in the second incident resource set “Set 2”, and a “1” is set in the place of the third-digit flag bit of each node included in the third incident resource set “Set 3”.

In S40 of FIG. 4, the apparatus 100 may combine the values of the flag bits inserted in each of the nodes included in each of the first, second, and third incident resource sets “Set 1”, “Set 2”, and “Set 3”, thereby obtaining a binary number. Then, the apparatus 100 may create an indicator based on the binary number.

More specifically, since the first-, second-, and third-flag bits of, for example, node 1 are all set to a value of “1”, the binary number 111 is obtained by combining the values of the first-, second-, and third-flag bits of node 1, and the apparatus 100 may create an indicator of node 1 based on the binary number 111. The term “indicator”, as used herein, denotes an identifier by which a node can be distinguished from other nodes, and FIG. 5 illustrates an example in which the decimal equivalent of the binary number obtained by combining the values of the flag bits of each of the nodes of each of the first, second, and third incident resource sets “Set 1”, “Set 2”, and “Set 3” is used as the indicator of a corresponding node. That is, the number 7, which is obtained by converting the binary number 111 to decimal, is created as the indicator of node 1.

In the case of node 6, the binary number 100 is obtained by combining the values of the first-, second-, and third-flag bits of node 6, and the decimal equivalent of the binary number 100, i.e., the number 7, is created as the indicator of node 6.

The apparatus 100 may classify the nodes included in each of the first, second, and third incident resource sets “Set 1”, “Set 2”, and “Set 3” according to the indicators of the nodes included in each of the first, second, and third incident resource sets “Set 1”, “Set 2”, and “Set 3” (S505).

Referring to FIG. 5, there are no nodes having an indicator of “1” or “6”. That is, there are no nodes included only in the first incident resource set “Set 1”. Also, there are no nodes belonging to both the second and third incident resource sets “Set 2” and “Set 3”, but not belonging to the first incident resource set “Set 1”.

Nodes 7 and 9 have an indicator of “2”. Nodes 7 and 9 are nodes included only in the second incident resource set “Set 2”.

Nodes 3 and 5 have an indicator of “3”. Nodes 3 and 5 are nodes included not only in the first incident resource set “Set 1”, but also in the second incident resource set “Set 2”.

Nodes 6 and 8 have an indicator of “4”. Nodes 6 and 8 are nodes included only in the third incident resource set “Set 3”.

Nodes 2 and 4 have an indicator of “5”. Nodes 2 and 4 are nodes included not only in the first incident resource set “Set 1”, but also in the third incident resource set “Set 3”.

Node 1 has an indicator of “7”. Node 1 belongs to all the first, second, and third incident resource sets “Set 1”, “Set 2”, and “Set 3”.

According to the result of the classification performed in S505, since nodes 6 and 8 are related to each other and both belong to the third incident resource set “Set 3”, the apparatus 100 cannot determine relations between the third incident resource node of the third incident resource set “Set 3” and other incident resource nodes. In this case, the apparatus 100 may determine that there is a relation only between nodes 6 and 8. Similarly, the apparatus 100 may determine that there is a relation only between nodes 7 and 9.

On the other hand, since nodes 3 and 5 are included not only in the first incident resource set “Set 1”, but also in the second incident resource set “Set 2”, nodes 3 and 5 are connected not only to the first incident resource node by N or less edges, but also to the second incident resource node by N or less edges. In this case, the apparatus 100 may determine that there is a relation between the first and second incident resource nodes.

The apparatus 100 may visualize the relations between the plurality of incident resources (S506) based on the result of the classification performed in S505, i.e., sets of incident resource sets that are determined to be related.

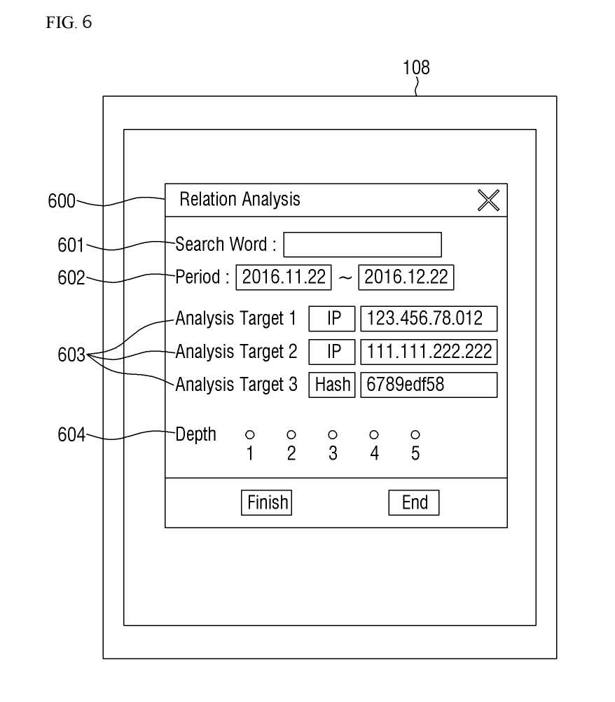

A method in which how the apparatus 100 displays relations between incident resources through a GUI will hereinafter be described with reference to FIGS. 6 through 11.

FIG. 6 is a diagram illustrating an interface for relation search according to some exemplary embodiments of the present disclosure.

Referring to FIG. 6, the apparatus 100 may display a GUI 600 via the display 108.

The GUI 600 may include an area 601 for entering search words, an area 602 for setting a period during which incident resources are collected, an area 603 for entering incident resources to be analyzed, and an area 604 for determining a search depth from each of the incident resources in terms of the number of edges.

Referring to the area 603, an IP address is entered as analysis target 1, another IP address is entered as analysis target 2, and a hash value is entered as analysis target 3.

The search depth determined in the area 604 is the depth from each of input incident resources to nodes to be searched for. That is, nodes connected to each of input incident resources and the number of other nodes connected to the nodes (which is connected to each of input incident resources) may be determined by the search depth determined in the area 604.

Once the user and/or the administrator enters information to each of the areas 601 through 604 of the GUI 600, the apparatus 100 may visualize relations between incident resources based on the entered information and using the graph database 106.

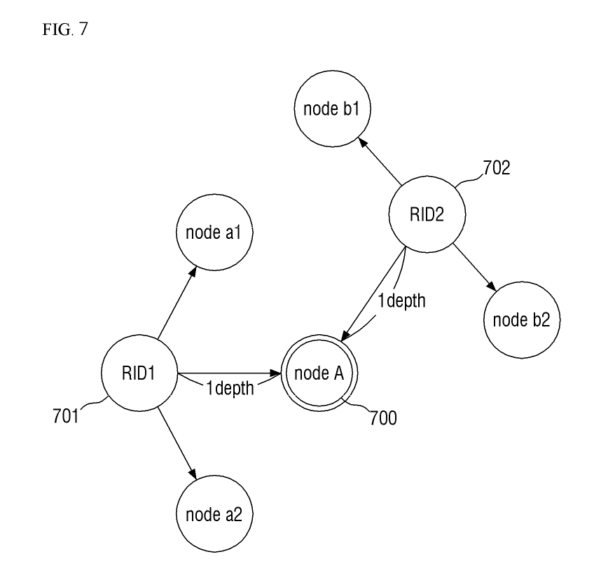

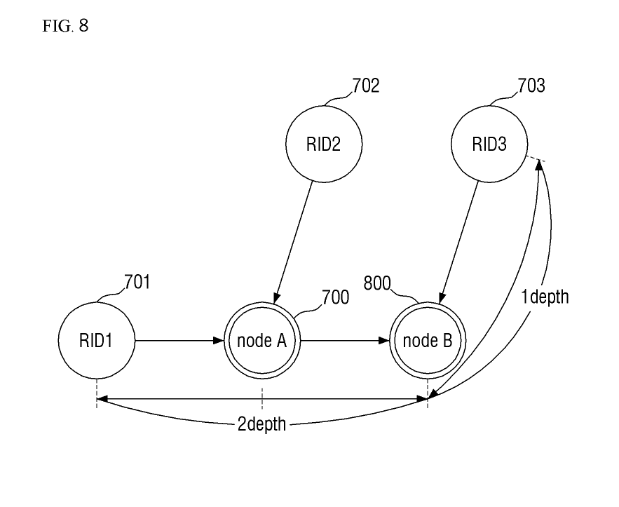

FIGS. 7 and 8 are diagrams illustrating incident resource nodes and incident resource sets according to some exemplary embodiments of the present disclosure.

Referring to FIG, 7, it is assumed that nodes matched to the input incident resource entered to the GUI 600 are nodes RID1 (701) and RID2 (702), and that a search depth is determined to be a one-edge depth.

Node RID1 (701) is connected to each of nodes a1 and a2 by one edge. An incident resource set corresponding to node RID1 (701) may include node A (700) and nodes a1 and a2.

Node RID2 (702) is connected to each of node A (700) and nodes b1 and b2 by one edge. An incident resource set corresponding to node RID2 (702) may include node A (700) and nodes b1 and b2.

Node A (700) is connected to each of nodes RID1 (701) and RID2 (702) by one edge. Node A (700) belongs to both the incident resource set corresponding to node RID1 (701) and the incident resource set corresponding to node RID2 (702). In this case, the apparatus 100 may determine that there is a relation between nodes RID1 (701) and RID2 (702), and may reflect node A (700) in a graph visualizing the relation between nodes RID1 (701) and RID2 (702). The apparatus 100 may exclude other nodes than nodes RID1 (701) and RID2 (702) and node A (700) from the graph visualizing the relation between nodes RID1 (701) and RID2 (702).

Referring to FIG. 8, it is assumed that nodes RID1 (701), RID2 (702), and RID3 (703) are matched to the input incident resource entered to the GUI 600, and that a search depth is determined to be a two-edge depth.

Node RID1 (701) is connected to node A (700) by one edge and is connected to node B (800) by two edges. An incident resource set (corresponding to node RID1 (701) may include node A (700) and node B (800).

Node RID2 (702) is connected to node A (700) by one edge and is connected to node B (800) by two edges. An incident resource set corresponding to node RID2 (702) may include node A (700) and node B (800). Node RID3 (703) is connected to node B (800) by one edge and is connected to node A (700) by two edges. An incident resource set corresponding to node RID3 (703) may include node B (800) and node A (700).

Node A (700) is connected to each of nodes RID1 (701) and RID2 (702) by one edge and is connected to node RID3 (703) by two edges. Node A (700) belongs to all the incident resource set corresponding to node RID1 (701), the incident resource set corresponding to node RID2 (702), and the incident resource set corresponding to node RID3 (703).

Node B (800) is connected to node RID3 (703) by one edge and is connected to each of nodes RID1 (701) and RID2 (702) by two edges. Node B (800) belongs to all the incident resource set corresponding to node RID1 (701), the incident resource set corresponding to node RID2 (702), and the incident resource set corresponding to node RID3 (703).

In this case, the apparatus 100 may determine that there are relations between nodes RID1 (701) and RID2 (702), between nodes RID1 (701) and RID3 (703), and between nodes RID2 (702) and RID3 (703), and may reflect nodes A (700) and B (800) in a graph visualizing the relations among nodes RID1 (701), RID2 (702), and RID3 (703).

As the search depth determined in the area 604 of FIG. 6 changes, the determination on the relations among nodes RID1 (701), RID2 (702), and RID3 (703) may change accordingly. In a case in which the search depth determined in the area 604 of FIG. 6 is a one-edge depth, the apparatus 100 may determine that there is no relation between nodes RID1 (701) and RID3 (703), and that there is also no relation between nodes RID2 (702) and RID3 (703).

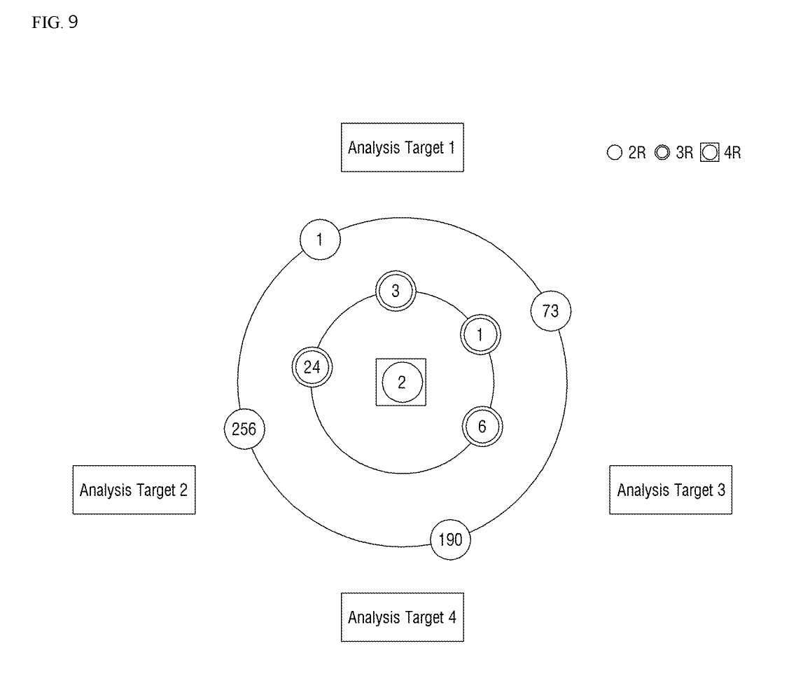

The apparatus 100 may display relations between incident resources through a GUI for relation visualization. Examples of the GUI for relation visualization will hereinafter be described with reference to FIGS. 9 through 11.

FIGS. 9 through 11 are diagrams illustrating a GUI for relation visualization according to some exemplary embodiments of the present disclosure.

The apparatus 100 may receive information regarding each of a plurality of incident resources. The received information may include the RIDs of the plurality of incident resources, indicating whether the plurality of incident resources are IP addresses or hash values, and information by which multiple incident resource nodes stored in the graph database 106, such as strings, which are elements of incident resources, can be identified.

The apparatus 100 may identify incident resource nodes to which the plurality of incident resources are mapped, from among the multiple incident resource nodes, based on the received information.

The apparatus 100 may determine an incident resource node set including nodes connected to each of the identified incident resource nodes by N or less edges.

If there exists one or more nodes belonging to two or more incident resource sets among the nodes included in each of the incident resource sets, the apparatus 100 may create a graph including the one or more nodes and incident resource nodes corresponding to, respectively, the two or more incident resource sets that the one or more nodes belong to. Then, the apparatus 100 may display the created graph through a GUI for relation visualization.

FIG. 9 illustrates a graph showing relations between incident resources, which can be displayed by a GUI for relation visualization, in a case in which analysis targets 1 through 4 are entered to the area 603 of the GUI 600 of FIG. 6, the apparatus 100.

Referring to FIG. 9, nodes of analysis targets 1 through 4 are shown as incident resource nodes, and nodes belonging to more than one incident resource set are also shown. The color and/or shape of each node may vary according to the number of incident resource sets that they belong to. For example, a node belonging to two incident resource sets may be represented by an object 2R, a node belonging to three incident resource sets may be represented by an object 3R, and a node belonging to four incident resource sets may be represented by an object 4R.

If there exists more than one node belonging to two or more resource sets among the nodes of each incident resource set, the number of nodes belonging to two or more incident resource sets among the nodes of each of the incident resource set may be displayed. That is, as illustrated in FIG. 9, the number of nodes belonging to two or more incident resource sets among the nodes of each of the incident resource set may be displayed in an object 2R, 3R, or 4R on one of a plurality of concentric circles. Four objects on an outermost one of the plurality of concentric circles represent nodes belonging to two incident resource sets among the nodes of each incident resource set. For example, each of the numbers 1, 73, 190, and 256 displayed in the four objects, respectively, represents the number of nodes belonging to two incident resource sets corresponding to two of the nodes of analysis targets 1 through 4.

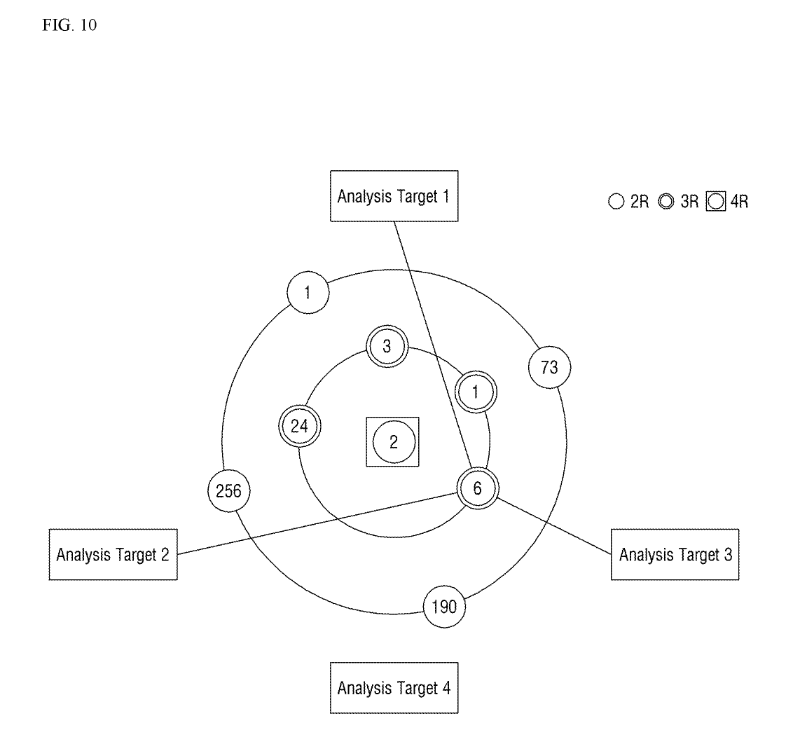

Referring to FIG. 10, in response to a selection of an object being received from the user and/or the administrator through the GUI for relation visualization provided by the apparatus 100, the apparatus 100 may display incident resource nodes respectively corresponding to incident resource sets that each node included in the selected object belongs to and may display a graph in which the incident resource nodes and the selected object are connected by edges.

In this manner, the user and/or the administrator can identify the incident resource node sets that each node included in the selected object belongs to. That is, the apparatus 100 can identify relations between a plurality of incident resources by using the selected object.

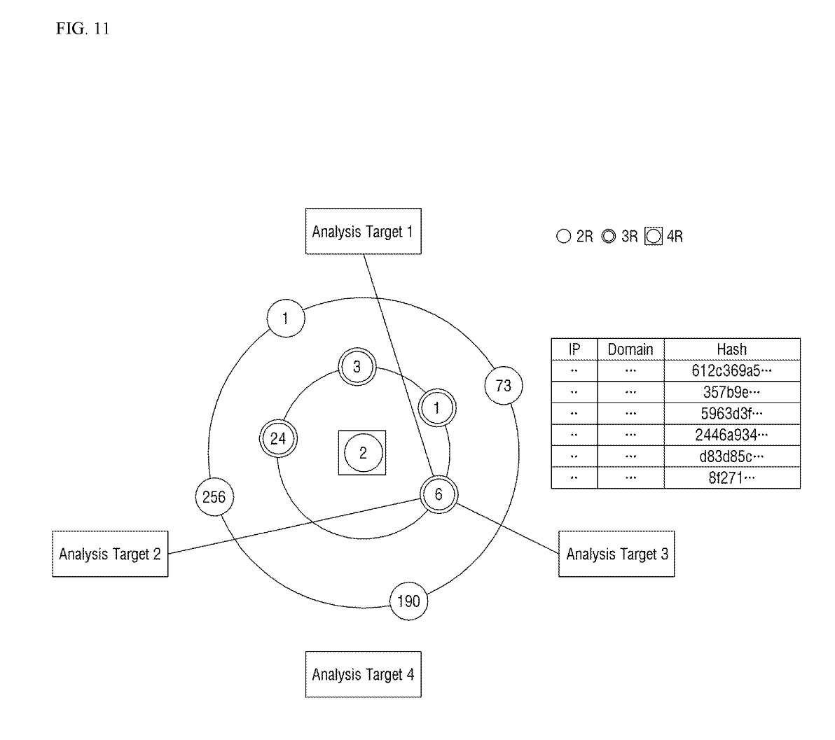

Referring to FIG. 11, in response to input for displaying the selected object being received via the GUI for relation visualization, the apparatus 100 may display information regarding each node included in the selected object.

For example, as illustrated in FIG. 11, information regarding six nodes included in the selected object is displayed in the form of a list, along with a graph showing the relations between incident resource nodes respectively corresponding to incident resource sets that each of the six nodes belongs to.

What is claimed is:

1. A method for visualizing relations between incident resources using a graph database including a plurality of resource nodes and edges connecting the plurality of resource nodes, the method comprising:
generating a first incident resource set including one or more nodes connected to a first incident resource node, which is one of the plurality of resource nodes, by N or less edges (where N is a natural number not less than 1);
generating a second incident resource set including one or more nodes connected to a second incident resource node, which is another one of the plurality of resource nodes, by N or less edges;
setting a first flag bit of the nodes included in the first incident resource set and a second flag bit of the nodes included in the second incident resource set to a first value;
classifying the nodes included in each of the first and second incident resource sets based on the values of the first and second flag bits of each of the nodes included in each of the first and second incident resource sets;
identifying one or more nodes belonging to both the first and second incident resource sets based on the result of the classification; and
determining that there is a relation between the first and second incident resource nodes if there exists one or more nodes belonging to both the first and second incident resource sets.

2. The method of claim 1, further comprising:
in response to it being determined that there is a relation between the first and second incident resource sets, generating a graph including the first and second incident resource sets and the nodes belonging to both the first and second incident resource sets; and
displaying the graph through a graphic user interface (GUI) for relation visualization,
wherein the graph is a graph in which the nodes belonging to both the first and second incident resource sets are connected to each of the first and second incident resource nodes by edges.

3. The method of claim 2, wherein
the generating the graph, comprises, in response to there existing multiple nodes belonging to both the first and second incident resource sets among the classified nodes, integrating the multiple nodes into a single node and displaying the number of nodes belonging to both the first and second incident resource sets in the single node, and
the graph is a graph in which the single node is connected to each of the first and second incident resource nodes by edges.

4. The method of claim 3, further comprising:
in response to a node being selected from the GUI, displaying a node value of the selected node.

5. The method of claim 1, wherein the nodes belonging to both the first and second incident resource sets are nodes whose first and second flag bits are both set to the first value.

6. The method of claim 5, wherein
the first and second flag bits have different digit places, and
the digit places of the first and second flag bits are adjacent to each other.

7. The method of claim 1, wherein the classifying the nodes included in each of the first and second incident resource sets, comprises generating an indicator of each of the nodes included in each of the first and second incident resource sets by combining the values of the first and second flag bits of each of the nodes included in each of the first and second incident resource sets, and classifying the nodes included in each of the first and second incident resource sets based on the indicators of the nodes included in each of the first and second incident resource sets.

8. The method of claim 1, further comprising:
in response to there existing multiple nodes belonging to only one of the first and second incident resource sets among the classified nodes, determining that there is a relation only between the multiple nodes.

9. A computer program, for visualizing relations between incident resources using a graph database including a plurality of resource nodes and edges connecting the plurality of resource nodes, which is coupled with a computer device and stored in a non-transitory computer readable recording medium, the program being configured to execute:
generating a first incident resource set including one or more nodes connected to a first incident resource node, which is one of the plurality of resource nodes, by N or less edges (where N is a natural number not less than 1);
generating a second incident resource set including one or more nodes connected to a second incident resource node, which is another one of the plurality of resource nodes, by N or less edges;
setting a first flag bit of the nodes included in the first incident resource set and a second flag bit of the nodes included in the second incident resource set to a first value;
classifying the nodes included in each of the first and second incident resource sets based on the values of the first and second flag bits of each of the nodes included in each of the first and second incident resource sets;
identifying one or more nodes belonging to both the first and second incident resource sets based on the result of the classification; and
determining that there is a relation between the first and second incident resource nodes if there exists one or more nodes belonging to both the first and second incident resource sets.

10. A method for visualizing relations between incident resources using a graph database including a plurality of resource nodes and edges connecting the plurality of resource nodes, the method comprising:
receiving information regarding each of multiple incident resources;
identifying multiple incident resource nodes mapped to the multiple incident resources, respectively, from among the plurality of resource nodes in response to receipt of the information;
determining an incident resource set including each of the multiple incident resource nodes and one or more nodes connected to a corresponding incident resource node by N or less edges (where N is a natural number not less than 1);
in response to there existing one or more nodes belonging to two or more incident resource sets among the nodes included in the determined incident resource set, generating a graph including the one or more nodes and incident resource nodes corresponding to the two or more incident resource sets, respectively, that the one or more nodes belong to; and
displaying the graph through a GUI for relation visualization.

11. The method of claim 10, wherein the determining the incident resource set, comprises setting a flag bit of the nodes included in each of the multiple incident resource sets to a first value and determining, based on the result of the setting, that the one or more nodes belong to the two or more incident resource sets.

12. The method of claim 11, wherein the displaying the graph, comprises displaying the graph such that at least one of a color and a shape of the one or more nodes can vary according to the number of incident resource sets that the one or more nodes belong to.

13. The method of claim 11, wherein the one or more nodes are nodes whose flag bit is set to the first value.

14. The method of claim 10, wherein the generating the graph, comprises in response to there existing more than one node belonging to two or more incident resource sets among the nodes included in the determined incident resource set, generating a graph displaying an object that shows the number of nodes belonging to two or more incident resource sets among the nodes included in the determined incident resource set.

15. The method of claim 14, further comprising:
in response to a selection of an object being received through the GUI, displaying information regarding the selected object.

16. A computer program, for visualizing relations between incident resources using a graph database including a plurality of resource nodes and edges connecting the plurality of resource nodes, which is coupled with a computer device and stored in a non-transitory computer readable recording medium, the program being configured to execute:
receiving information regarding each of multiple incident resources;
identifying multiple incident resource nodes mapped to the multiple incident resources, respectively, from among the plurality of resource nodes in response to receipt of the information;
determining an incident resource set including each of the multiple incident resource nodes and one or more nodes connected to a corresponding incident resource node by N or less edges (where N is a natural number not less than 1);
in response to there existing one or more nodes belonging to two or more incident resource sets among the nodes included in the determined incident resource set, generating a graph including the one or more nodes and incident resource nodes corresponding to the two or more incident resource sets, respectively, that the one or more nodes belong to; and
displaying the graph through a GUI for relation visualization.
